(19) United States
(12) Patent Application Publication
(10) Pub. No.: US 2008/0163901 A1
(43) Pub. Date: Jul. 10, 2008

(54) Sump of Dish Washer

(76) Inventor: Sang Woo Woo, Kyoungsangbuk-do (KR)

Correspondence Address: MCKENNA LONG & ALDRIDGE LLP, 1900 K STREET, NW, WASHINGTON, DC, 20006, US

(21) Appl. No.: 10/568,443

(22) PCT Filed: May 25, 2005
(86) PCT No.: PCT/KR05/01544

§ 371 Date: Feb. 15, 2006

(30) Foreign Application Priority Data
Jun. 24, 2004 (KR) 10-2004-00047443

(51) Int. Cl. B08B 3/00

(52) U.S. Cl. 134/105

(57) ABSTRACT

A sump assembly of a dishwasher includes a sump housing having a washing water storing portion, a water supply connector formed on a first portion of the washing water storing portion, and a heater insertion hole formed on a second portion of the washing waster storing portion, which is opposite to the first portion, a water infiltration preventing rib extending from an outer bottom surface of the sump housing, a heater inserted into the washing water storing portion, and a washing motor mounted under the sump housing.

### TECHNICAL FIELD

The present invention relates to a dishwasher, and more particularly, to a sump of a dishwasher that is designed to protect a motor installed under the sump from a leak of water.

### BACKGROUND ART

Generally, a dishwasher is one of electronic appliances, which can wash dishes by removing garbage from the dishes using water sprayed through a spraying nozzle.

A typical dishwasher includes a tub in which the dishes are received and washed, a sump installed under the tub to store washing water, a washing pump for pumping out the washing water stored in the sump to a spraying nozzle, a washing motor for driving the washing pump, a drain pump for draining the waste water after the washing operation is finished, and a drain motor for driving the drain pump.

Meanwhile, the washing pump is mounted on a sidewall of the sump while the washing motor for driving the washing pump is mounted in rear of the washing pump. The washing pump is mounted inside the sump. The washing motor is mounted under the sump so that the washing motor and the washing pump are aligned on an identical vertical line.

When the washing motor is installed under the sump, washing water leaking from the sump may flow to the washing motor, causing the malfunction of the washing motor or other electrical problems.

For example, the washing water may leak from the water supplying connector formed on a sidewall of the sump or from a heater insertion hole formed on another sidewall of the sump to allow a heat can be inserted therethrough.

### DISCLOSURE OF INVENTION

### Technical Problem

Therefore, the present invention has been made in an effort to solve the above-described problems of the typical dishwasher. It is an object of the present invention to provide a sump assembly of a dishwasher, which can prevent washing water leaking from the sump from flowing to a motor mounted under the sump.

### Technical Solution

To achieve the above object, the present invention provides a sump assembly of a dishwasher comprising: a sump housing having a washing water storing portion, a water supply connector formed on a first portion of the washing water storing portion, and a heater insertion hole formed on a second portion of the washing waster storing portion, which is opposite to the first portion; a water infiltration preventing rib extending from an outer bottom surface of the sump housing; a heater inserted into the washing water storing portion; and a washing motor mounted under the sump housing.

According to another aspect of the present invention, there is provided a sump assembly of a dishwasher comprising: a heater heating washing water; a sump housing having a heater receiving portion, a water supply connector formed on a first portion of the heater receiving portion, and a heater insertion hole formed on a second portion of the heater receiving portion, which is opposite to the first portion; and a washing pump received in the sump housing to pump out the washing water, wherein a portion of an outer bottom surface of the sump housing extends downward to prevent the washing water from infiltrating into the washing motor.

### Advantageous Effects

According to a sump assembly of a dishwasher of the present invention, the motor can be protected from the washing water even when the washing water leaks form a coupling portion, a water supply opening or other portions that define a sump assembly.

Furthermore, the malfunction of the washing motor and a fire by a short circuit, which may be caused by the leakage of the washing water, can be prevented.

### BRIEF DESCRIPTION OF THE DRAWINGS

FIG. 1 is a sectional view of a dishwasher employing a sump assembly according to an embodiment of the present invention;

FIG. 2 is an exploded perspective view of a sump assembly according to an embodiment of the present invention;

FIG. 3 is a rear view of a sump housing with a motor protective device according to one embodiment of the present invention; and

FIG. 4 is a rear perspective view of a sump housing where a motor is mounted according to one embodiment of the present invention.

### BEST MODE FOR CARRYING OUT THE INVENTION

Reference will now be made in detail to the preferred embodiments of the present invention. It is to be understood that the following detailed description of the present invention does not limit the present invention but various modifications and variations can be made in the present invention. Thus, it is intended that the present invention covers the modifications and variations of this invention provided they come within the scope of the present invention.

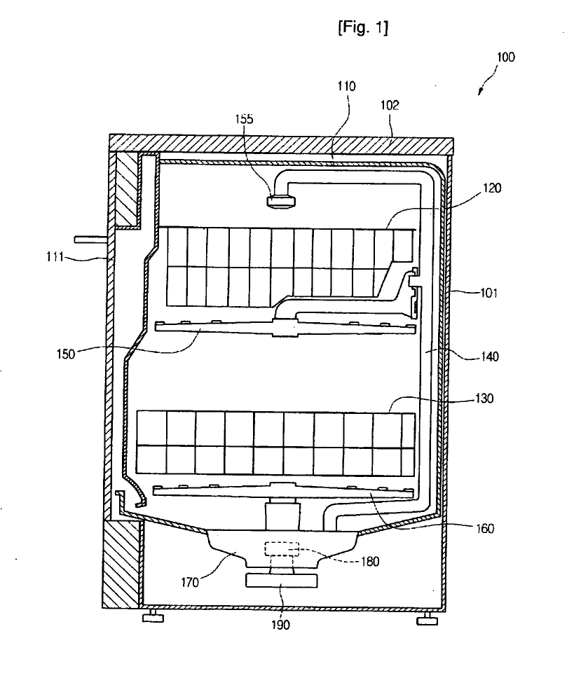

FIG. 1 is a schematic sectional view of a dishwasher employing a sump assembly according to an embodiment of the present invention.

Referring to FIG. 1, the dishwasher 100 having a sump assembly of the present invention includes a cabinet 101 defining an outer appearance, a top cover 102 covering a top of the cabinet 101, a tub 110 installed in the cabinet 101 to define a dish washing tank, a door 111 installed in front of the tub 110 to open and close the dish washing tank, and a sump 200 installed on a bottom center of the tub 110 to store washing water.

The dishwasher 100 further includes a water guide 140 defining a flowing path of the washing water pumped out by a washing pump, a lower nozzle 160 mounted on a top of the sump 200 to spray the washing water upward in the tub 110, an upper nozzle 150 extending toward a center of the tub 110 from an upper portion of the water guide 140 to spray the washing water upward, and a top nozzle 155 mounted on the ceiling of the tub 110 to spray the washing water downward.

The dishwasher 100 further includes an upper rack 120 mounted above the upper nozzle 150 to wash the dishes disposed therein by the upper nozzle 150 and a lower rack 130 mounted above the lower nozzle 160 to wash the dishes disposed therein by the lower nozzle 160.

That is, the upper rack 120 is supported on a rail (not shown) provided on an inner wall of the tub 110 and is slidable frontward and rearward.

The operation of the dishwasher 100 will be described hereinafter.

A user first opens the door 11 and pulls the upper and/or lower racks 120 and/or 130 frontward. Then, the dishes are loaded in the racks 120 and 130 and the door 111 is closed, after which the power is turned on to operate the dishwasher 100.

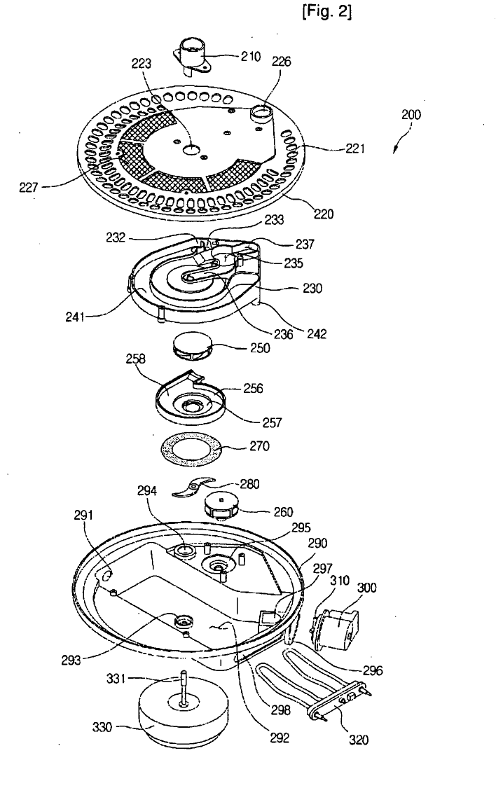

When the dishwasher 100 operates, the washing water flows into the sump 200, after which the washing motor 330 operates. Here, while the washing water flows into the sump 200, the washing water is heated by a heater (refer to the reference numeral 320 of FIG. 2) installed in the sump 200. The washing water is alternately pumped to the lower nozzle 160 and the water guide 140 as an impeller (not shown) provided in a washing pump (not shown) shaft-connected to the washing motor 330 rotates.

The washing water pumped to the water guide 140 is directed to the top nozzle 155 and the upper nozzle 150 and is then sprayed into the tub 110. The washing water pumped to the lower nozzle 160 is sprayed into the tub 110 through spraying holes formed on the lower nozzle 160. By the spraying of the washing nozzle, the dishes loaded in the upper and lower racks 120 and 130 are washed.

The top nozzle 155 is designed to spray the washing water downward while the upper nozzle 150 is designed to spray the washing water upward, thereby washing the dishes loaded in the upper rack 120.

The lower nozzle 160 is designed to spray the washing water upward to washing the dishes loaded in the lower rack 130. The upper nozzle 150 may be further provided at a bottom with spraying holes so that the washing water can be sprayed upward and downward, thereby simultaneously washing both sides of the dishes loaded in both the upper and lower racks.

When the washing process is finished, the waste water used for the washing and collected in the sump 200 is drained out of the dishwasher through a drain pump (not shown).

When the waste water is drained, new washing water is introduced into the sump 200 through a water supply hole and is then sprayed through the spraying nozzles 150 and 160 as in the above. By the new washing water, the dishes go through a rinsing process.

After the rinsing process; is finished, the dishes go through a dry process, thereby completing the washing operation.

FIG. 2 is an exploded perspective view of a sump assembly according to an embodiment of the present invention.

Referring to FIG. 2, the sump 200 of the present invention includes a sump housing 290 for storing washing water supplied through a washing water supply tube, a washing motor 330 mounted under the sump housing 290, and a disposer connected to a motor shaft 331 to grind the garbage.

The sump 200 further includes a pump case that is mounted on the disposer 280 and to which the washing water stored in the sump housing 290 is pumped and an impeller 250 disposed in the pump case to pump out the washing water while rotating. That is, the motor shaft 331 is inserted into a center of the impeller 250 to pump out the washing water while rotating together with the motor shaft 331.

The sump 200 further includes a mesh filter 270 disposed between the disposer 280 and the pump case 256 to filter large volume garbage among the garbage ground by the disposer 280, thereby preventing the large volume garbage from going into the pump case 256.

The sump 200 further includes a soil chamber 230 provided with a pumping passage guiding the flow of the washing water pumped from the pump case. The soil chamber 230 covers the top of the pump case 256.

The sump 200 further includes a filter 220 disposed on an upper sidewall of the soil chamber 230 and provided at a peripheral portion with a spraying nozzle connector. That is, the spray nozzle connector is connected to the spray nozzle to guide the washing water supplied along the pumping passage formed on the soil chamber 230 to the spray nozzle. A vario valve 260 for selectively guiding the washing water fed along the pumping passage is mounted on a portion of the soil chamber 230. A lower nozzle arm holder 210 is mounted on a center portion of the filter 220 to mount the lower nozzle 160.

That is, the filter 220 is provided at a peripheral portion with washing water through holes 221 and a mesh filter 227 that are designed to firstly filter garbage directly removed from the dishes. The filter 220 is further provided at a center portion with an insertion hole 223 in which the lower nozzle arm holder 210 is mounted. The filter 220 is further provided at a portion of the peripheral portion with a water guide insertion sleeve 226 in which a lower end of the water guide 140 is inserted. The water guide insertion sleeve 226 has a predetermined length and height. That is, as described above, the water guide 140 is a washing water flowing tube formed in a O-shape extending from a bottom of the tub to an upper side of the tube so that the washing water pumped out by the washing pump 256 to be directed to the upper nozzle 150 and the top nozzle 155.

The soil chamber 230 is provided at a portion with a vario valve seating portion 235 on which the vario valve 260 is disposed. The soil chamber 230 is further provided with a lower nozzle guide passage 236 bending from the vario valve seating portion 235 and a water guide passage 237 guiding the washing water from the vario valve seating portion 235 to the water guide insertion sleeve 226.

The soil chamber 230 is further provided a drain passage 241 formed along an edge of the soil chamber 230 and having a predetermined width and depth. A muddy detecting sensor insertion hole 232 is formed on a first end of the drain passage 241 to receive a muddy detecting sensor. A drain hole is formed on a second end of the drain passage 241; being connected to the drain pump and the bottom of the sump. The muddy detecting sensor is a pollution detecting sensor that detects the pollution level while the washing process is being performed. The drain hole 242 extends downward from the bottom of the soil chamber 230.

The soil chamber 230 is further provided with a muddy sensor guide passage 233 for guiding the washing water pumped out from the pump case 256 to the muddy sensor inserted in the muddy sensor insertion hole 232.

Meanwhile, the washing water falling toward the washing water through holes 221 is collected in the sump housing 290. The washing water falling toward the mesh filter 227 passes through the mesh filter 227 while foreign objects contained therein are filtered by the mesh filter 227. The washing water whose foreign objects are filtered flows along the drain passage 241 provided under the mesh filter 227 and dropt through the drain hole 242. Then, the dropt washing water is directed to the drain pump. When the washing water is fully filled in the drain pump, this washing water reversely flows to the sump housing 290 via the mesh filter 227 and the washing water through holes 221. At this point, by the reversely flowing washing water, the foreign objects caught by the mesh filter 227 is collected in the sump housing 290 through the washing water through holes 221.

In addition, the pump case 256 is provided at an inner surface with an impeller seating groove 257 for seating the impeller 250 at a center portion. Defined between the outer circumference of the impeller seating groove 257 and the outer circumference of the pump case 256 is a pumping passage 258. The pumping passage 258 is designed having a predetermined depth by an outer wall of the pump case 256. Therefore, the washing water directed into the pump case 256 flows to the vario valve 260 along the pumping passage 258.

The sump housing 290 includes a water supply connector 291 formed extending from the bottom, a drain pump case 296 depressed at an opposite side of the water supply connector 291, and a heater receiving portion 292 formed by depressing the inner center.

A motor shaft penetrating hole 293 is formed on a center of the heater receiving portion 292 and a heater insertion hole 298 formed on a sidewall of the sump housing 290.

The drain pump case 296 is connected to the soil chamber drain hole 297 and the drain motor 300 is mounted on the drain pump case 296. That is, the drain impeller 310 is mounted in front of the drain motor 300 that rotates in the drain pump case 296 to drain the washing water through a drain hose. A vario valve seating groove 295 is formed on an outer portion of the heater receiving portion 292 and a muddy detecting sensor seating groove 294 is formed at a portion distant from the vario valve seating groove 295.

A flow of the washing water in the sump assembly of the present invention will be described hereinafter in more detail.

As the washing motor 330 rotates, the impeller 250 mounted in the pump case 256 rotates together therewith. By the rotation of the impeller 250, the washing water stored in the sump housing 290 flows into the pump case 256. The washing water pumped out by the rotation of the impeller 250 is firstly purified while passing through the mesh filter 270. The purified washing water is guided to the water guide 140 or the lower nozzle 160 along the pumping passage 258. Here, the washing water is branched off by the vario valve 260 and is then guided to the upper or lower nozzle along the lower nozzle guide passage 236 and the water guide passage 237.

Describing in more detail, the vario valve 260 is designed to allow only one of the upper and lower nozzles 150 and 160 to be opened for a predetermined time. After the predetermined time has lapsed, the other one of the upper and lower nozzles 150 and 160 is opened. That is, the vario valve 260 is designed to alternately spray the washing water through the upper and lower nozzles.

A part of the washing water flowing along the passage passes through the muddy detecting sensor (not shown), after which it falls toward the drain hole 242 along the drain passage 241 formed on the edge of the soil chamber 230. The falling washing water is collected in the drain pump case 296 through the soil chamber drain hole 297. When the drain pump case 296 is fully filled with the washing water, the washing water reversely flows toward the drain passage 241.

At this point, the reversely flowing washing water passes through the mesh filter 227 to be directed to the bottom of the tub 110, after which it is directed to the heater receiving portion 292 of the sump housing 290. Here, the minute garbage contained in the washing water passing through the mesh filter 227 is filtered by the mesh filter 227. The filtered garbage is accumulated on the drain passage 241 and then exhausted to an external side while the washing water is drained.

In the washing water draining process, the washing water is directed to the drain pump case 296, and when the drain motor 300 operates, the washing water directed to the drain pump case 296 is drained by the rotation of the drain impeller 310. At this point, the drain pump case 296 communicates with the soil chamber drain hole 297, and at the same time, with the heat receiving portion 296. As a result, when the draining starts, the garbage and washing water accumulated on the drain passage 241 and the washing water collected in the heat receiving portion 296 are all drained.

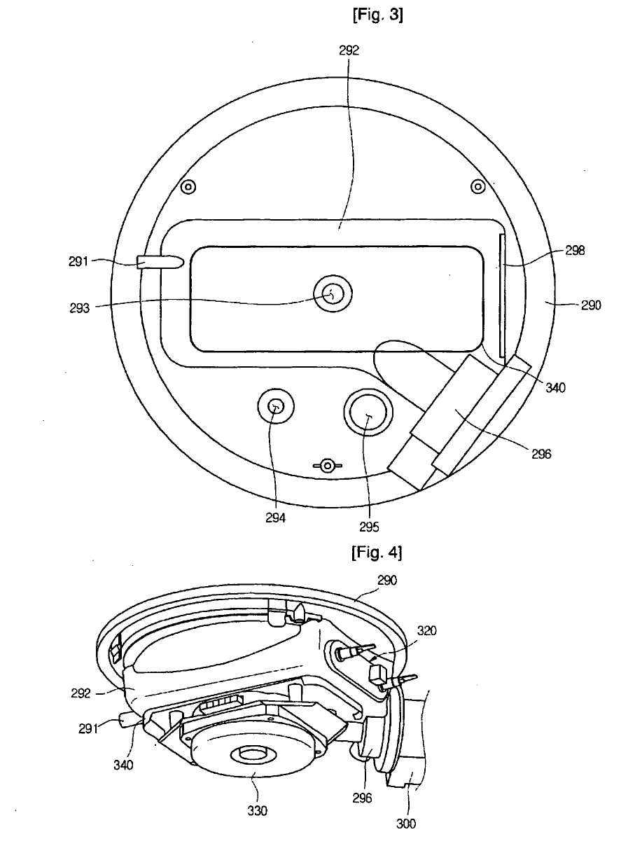

FIG. 3 is a rear view of a sump housing with a motor protective device according to one embodiment of the present invention and FIG. 4 is a rear perspective view of a sump housing where a motor is mounted according to one embodiment of the present invention.

Referring to FIGS. 3 and 4, the sump assembly of the present invention has a structure for preventing the washing water from flowing to the washing motor 330 disposed under the sump.

That is, the sump housing 290 is provided with the heat receiving portion 292 depressed at a predetermined depth. The water supply connector 291 is formed extending from the sidewall of the heat receiving portion 292. The heater insertion hole 298 is formed on a portion of the sidewall, which is opposite to a portion where the water supply connector 291 is formed. A water infiltration preventing rib 340 is formed extending downward from an outer bottom surface of the sump housing 290.

Describing in more detail, it is preferable that the bottom surface of the heat receiving portion 292 is formed in a rectangular shape. The water infiltration preventing rib 340 is formed along an edge of the outer bottom surface of the heater receiving portion 292. However, the water infiltration preventing rib 340 extends downward at a portion right under the water supply connector 291 and the heat insertion hole 298. Preferably, the water infiltration preventing rib 340 is integrally formed with the sump housing through an injection molding process.

In addition, a portion of the water infiltration preventing rib 340, which is located right under the water supply connector 291 and/or the heater insertion hole 298, is designed to be greater in a vertical length than those of other portions. That is, it is preferable that a portion of the water infiltration preventing rib 340, which corresponds to the water supply connector 291 or the beater insertion hole 298, is formed further extending downward than other portions since the leak possibility at the water supply connector 291 and the heater insertion hole 298 is higher than that at other portions.

In addition, the water infiltration preventing rib 340 may be designed to be inclined outward from the sump housing 290 with reference to a vertical line. By doing this, a distance between the washing motor 330 and the water infiltration preventing rib 340 is to be increased. As a result, the possibility that the washing water flows along the water infiltration preventing rib 340 can be lowered.

The operation of the sump 200 with the water infiltration preventing rib 340 will be described hereinafter.

When the washing water leaks through the water supply connector 291 and the heater mounting portion that are formed on the sump housing 290, the water flows along the outer circumference of the sump housing 290. At this point, the leaking water cannot be directed to the washing motor 330 disposed under the sump housing 290 by the water infiltration preventing rib 340. That is, the flow of the leaking water toward the washing motor 330 is blocked by the water infiltration preventing rib 340. That is, the leaking water flows along the outer wall of the water infiltration preventing rib 340 and falls down to a floor. Here, since the washing motor 330 is disposed at a portion enclosed by the water infiltration preventing rib 340, the drops of the washing water on the lower end of the water infiltration preventing rib 340 cannot flow toward the washing motor 330.

### INDUSTRIAL APPLICABILITY

According to the inventive sump assembly, since it can prevent washing water leaking from the sump from flowing to a motor mounted under the sump, the industrial applicability thereof is very high.

1. A sump assembly of a dishwasher comprising:
a sump housing having a washing water storing portion, a water supply connector formed on a first portion of the washing water storing portion, and a heater insertion hole formed on a second portion of the washing waster storing portion, which is opposite to the first portion;
a water infiltration preventing rib extending from an outer bottom surface of the sump housing;
a heater inserted into the washing water storing portion; and
a washing motor mounted under the sump housing.

2. The sump assembly according to claim 1, wherein the water infiltration preventing rib is formed along an edge of the outer bottom surface of the washing water storing portion.

3. The sump assembly according to claim 1, wherein a portion of the water infiltration preventing rib, which correspond to the water supply connector and/or the heater insertion hole, is greater in a vertical length than other portion.

4. The sump assembly according to claim 1, wherein the water infiltration preventing rib is inclined outward of the sump housing.

5. The sump assembly according to claim 1, wherein the water infiltration preventing rib is integrally formed with the sump housing.

6. The sump assembly according to claim 1, wherein a lower end of the water infiltration preventing rib is distant from the washing motor by a predetermined distance.

7. The sump assembly according to claim 1, wherein the water infiltration preventing rib is formed in a closed-circle shape on the outer bottom surface of the sump housing.

8. A sump assembly of a dishwasher comprising:
a heater heating washing water;
a sump housing having a heater receiving portion, a water supply connector formed on a first portion of the heater receiving portion, and a heater insertion hole formed on a second portion of the heater receiving portion, which is opposite to the first portion; and
a washing pump received in the sump housing to pump out the washing water, wherein a portion of an outer bottom surface of the sump housing extends downward to prevent the washing water from infiltrating into the washing motor.

9. The sump assembly according to claim 8, wherein a height of the extending portion is reduced as it goes away from the water supply connector and/or the heater insertion hole.

10. The sump assembly according to claim 8, wherein the extending portion is formed around the washing motor.

11. The sump assembly according to claim 8, wherein a lower end of the extending portion is distant from the motor by a predetermined gap.

12. The sump assembly according to claim 8, wherein the extending portion is formed along an edge of the outer bottom surface of the heater receiving portion and corner portions of the extending portion are curved at a predetermined curvature.

13. The sump assembly according to claim 8, wherein the extending portion is formed only at a portion corresponding to the heater insertion connector and/or the heater insertion hole.
